(19) United States
(12) Patent Application Publication
(10) Pub. No.: US 2015/0215658 A1
(43) Pub. Date: Jul. 30, 2015

(54) BYPASSING APPARATUS AND METHOD FOR PROVIDING CONTENT

(71) Applicant: Electronics and Telecommunications Research Institute, Daejeon (KR)

(72) Inventors: NAM KYUNG LEE, Daejeon (KR); IL GU JUNG, Daejeon (KR); WON RYU, Seoul (KR)

(21) Appl. No.: 14/482,676

(22) Filed: Sep. 10, 2014

(30) Foreign Application Priority Data
Jan. 27, 2014 (KR) 10-2014-0009777

(51) Int. Cl. H04N 21/2343; H04N 21/6437; H04N 21/61

(52) U.S. Cl. CPC H04N 21/234336; H04N 21/6125; H04N 21/6437

(57) ABSTRACT

A bypassing apparatus for providing content, the apparatus including: a processor configured to determine whether content for which a service request has been received is acceptable in a service platform terminal based on service platform profile information about the content for which a service request has been received; a content collector configured to collect, from a content provider, the content for which a service request has been received; and a content converter configured to convert the collected content into a form that is acceptable in the service platform terminal, in which the bypassing apparatus for providing content may further includes a profile manager configured to store the service platform profile information and in response to a request of the processor, to transmit, to the processor, service platform profile information about the content for which a service request has been received.

### CROSS-REFERENCE TO RELATED APPLICATION(S)

This application claims priority from Korean Patent Application No. 10-2014-0009777, filed on Jan. 27, 2014, in the Korean Intellectual Property Office, the entire disclosure of which is incorporated herein by reference for all purposes.

### BACKGROUND

1. Field

The following description generally relates to a broadcast service technology, and more particularly, to a bypassing method for providing a cloud-based broadcast service.

2. Description of the Related Art

Conventionally, broadcast services used to provide only simple types of broadcast content, but the development of broadcast service technology and smart devices has ushered in new broadcast services such as the IPTV and the smart TV, and more recently, various types of content are being provided by broadcast services combined with a cloud technology. Services provided by the cloud-based IPTV system have real-time features in which the basic services represented as broadcast or communication services are integrated with each other. Among these services, the communication services that are represented as application services, such as Web App, Widget, or Web Browser, enable service subscribers to an IPTV system based on the cloud system to access various types of content. However, receivers used by these subscribers make it difficult to provide services effectively, due to constraints on either the content encoding method adopted by the service provider to be used on the service platform or the data transmission protocol used on that service platform.

Korean Laid-open Patent Publication No. 10-2012-0122616 discloses a method for providing a universal digital rights management (DRM) format, which enables the DRM content obtained by a user terminal from a service provider to be used even in a case where each of the service provider and the user terminal supports different types of a DRM system. However, although intended to provide universal services, the Korean application provides only a universal format of a DRM license, such that problems, which are caused by the constraints on either the content encoding method adopted by the service provider to be used on the service platform or the data transmission protocol used on the service platform, still remain.

### RELATED ART DOCUMENT

### Patent Document

Korean Laid-open Patent Publication No. 10-2012-0122616

### SUMMARY

Disclosed is a bypassing apparatus and method for providing various types of broadcast content, without any constraints on either the content encoding method adopted by a service provider to be used on a service platform or the data transmission protocol used on the service platform.

In one general aspect, there is provided a bypassing apparatus for providing content, the apparatus including: a processor configured to determine whether content for which a service request has been received is acceptable in a service platform terminal based on service platform profile information about the content for which a service request has been received; a content collector configured to collect, from a content provider, the content for which a service request has been received; and a content converter configured to convert the collected content into a form that is acceptable in the service platform terminal.

The bypassing apparatus for providing content may further include a profile manager configured to store the service platform profile information and in response to a request of the processor, to transmit, to the processor, service platform profile information about the content for which a service request has been received.

The processor may determine whether the content is acceptable in the service platform terminal based on the service platform profile information including container information and codec information of the content provided by the content provider.

In response to a determination that the content is acceptable in the service platform terminal, the processor allocates sessions to create a service channel to the service platform terminal.

The processor may allocate the sessions using a real time streaming protocol (RTSP) connection to create the service channel.

The content converter may convert the container of the collected content into a form that is acceptable in the service platform terminal by transformatting.

The content may convert the codec of the collected content into a form that is acceptable in the service platform terminal by transcoding.

In another general aspect, there is provided a bypassing method for providing content, the method including: analyzing service platform profile information about content for which a service request has been received; determining whether the content for which a service request has been received is acceptable in a service platform terminal based on the analyzed service platform profile information; collecting, from a content provider, the content for which a service request has been received; and converting the collected content into a form that is acceptable in the service platform terminal.

The determining whether the content is acceptable in a service platform terminal based on the analyzed service platform profile information may include determining whether the content is acceptable in the service platform terminal based on the service platform profile information including container information and codec information of content.

The method may further include allocating sessions to create a service channel to the service platform terminal in response to a determination that the content is acceptable in the service platform terminal.

### BRIEF DESCRIPTION OF THE DRAWINGS

FIG. 1 is a block diagram illustrating an example of a bypassing apparatus for providing content according to an exemplary embodiment.

FIG. 2 is a detailed block diagram illustrating an example of a bypassing apparatus for providing content according to an exemplary embodiment.

FIG. 3 is a block diagram illustrating an example of service platform profile information of a bypassing apparatus for providing content according to an exemplary embodiment.

FIG. 4 is a block diagram illustrating an example of a conversion table of a content converter of a bypassing apparatus for providing content according to an exemplary embodiment.

FIG. 5 is a flowchart illustrating a data flow of a bypassing apparatus for providing content according to an exemplary embodiment.

FIG. 6 is a flowchart illustrating an example of a bypassing method for providing content according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

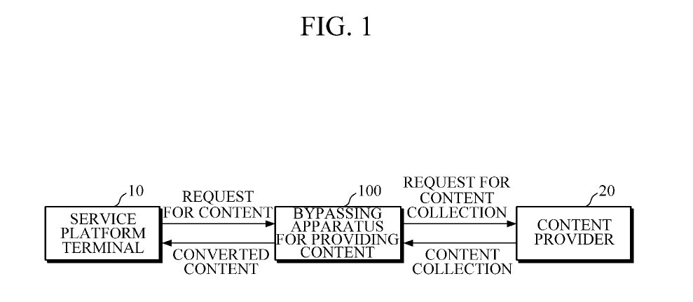

FIG. 1 is a block diagram illustrating an example of a bypassing apparatus for providing content according to an exemplary embodiment. Referring to FIG. 1, when the bypassing apparatus 100 for providing content receives a request for content from a service platform terminal 10, the bypassing apparatus 100 for providing content receives, from a content provider 20, content for which a service request has been received. Further, in a case where the received content is unacceptable (unavailable) in the service platform terminal 10, the bypassing apparatus 100 for providing content converts the content into a form that is acceptable in the service platform terminal 10, and transmits the converted content to the service platform terminal 10.

By using a service platform or the service platform terminal 10 that allows access to a service platform, a user (service subscriber) accesses the service platform to search for a desired content service, and requests the desired content service from the bypassing apparatus 100 for providing content. The user's request for a content service is indicated by a service ID and transmitted to the bypassing apparatus 100 for providing content. The service platform may be a web page, or a separate application, which may search for and request content that is provided by the service provider 20. The service platform terminal 10 is a terminal that may access a web page that provides a service platform, or a terminal in which a service platform may be embedded or installed. The service platform terminal 10 may be in various forms, such as a PC, a TV, a smartphone, a tablet PC, and a set top box.

Further, based on service platform profile information, the bypassing apparatus 100 for providing content may identify container information and codec information of content requested by the service platform terminal 10. The bypassing apparatus 100 for providing content determines whether the content is acceptable (available) in the service platform terminal 10 based on the container information and codec information of the requested content. If the content is determined as unacceptable, the bypassing apparatus 100 for providing content allocates a series of sessions to secure content conversion resources. Based on the identified container information and codec information, the bypassing apparatus 100 for providing content determines whether or not to convert a format and codec of content. The content provider 20 provides various types of content to a user through a service platform, and among a plurality of content providers that may be accessible, the bypassing apparatus 100 for providing content requests the content from a content provider 20, which is selected to be able to provide the requested content based on the service platform profile information analyzed by the bypassing apparatus 100 for providing content.

In response to receiving, from the content provider 20, content requested by a user through the service platform terminal 10, the bypassing apparatus 100 for providing content converts, based on the service platform profile information, a format and codec of the received content into a form that is acceptable in the service platform terminal 10. The bypassing apparatus 100 for providing content includes a transformatting functional block and a transcoding functional block to convert a container of the received content. The bypassing apparatus 100 for providing content converts the collected content into a form that is acceptable (available) in the service platform terminal 10 through the transformatting functional block and the transcoding functional block. In response to the conversion of content into a form acceptable (available) in the service platform terminal 10, the bypassing apparatus 100 for providing content transmits the converted content to the service platform terminal 10 through allocated sessions.

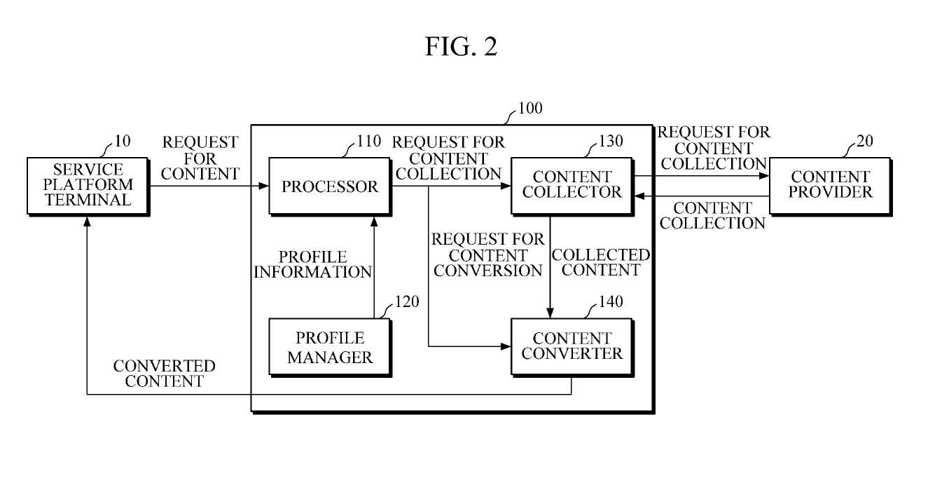

FIG. 2 is a detailed block diagram illustrating an example of a bypassing apparatus for providing content according to an exemplary embodiment.

Referring to FIG. 2, the bypassing apparatus 100 for providing content includes a processor 110, a profile manager 120, a content collector 140, and a content converter 140.

By using a service platform or a service platform terminal that allows access to a service platform, a user (service subscriber) accesses the service platform to search for a desired content service, and requests the desired content service from the bypassing apparatus 100 for providing content. The user's request for a content service is indicated by a service ID and transmitted to the bypassing apparatus 100 for providing content.

The service platform may be a web page, or a separate application, which may search for and request content that is provided by the service provider 20. The service platform terminal 10 is a terminal that may access a web page that provides a service platform, or a terminal in which a service platform may be embedded or installed. The service platform terminal 10 may be in various forms, such as a PC, a TV, a smartphone, a tablet PC, and a set top box.

In response to receiving a request for a content service from the service platform terminal 10, the processor 110 retrieves profile information of the service platform from the profile manager 120. Based on the service platform profile information, the processor 110 collects available content information of the service platform. Upon identifying the available content information based on the service platform profile information, the processor 110 requests the content collector 130 to collect content requested by a user through the service platform terminal 10.

Based on the service platform profile information, the processor 110 may identify container information and codec information of content requested by the service platform terminal 10. Based on the container information and the codec information of the requested content, the processor 110 determines whether the content may be acceptable (available) in the service platform terminal 10. If the content is determined as unacceptable, the processor 110 allocates a series of sessions to secure content conversion resources. The processor 110 determines whether or not to convert a format and codec of content based on the identified container information and codec information, and transmits, to the content converter 140, a request for content conversion so that content may be converted according to the determined format and codec.

The processor 110 transmits a request for content collection to the content collector 130, transmits a request for content conversion to the content converter 140, and creates a service channel to the service platform terminal 10. In response to sessions being allocated, a service channel is set up for content transmission among the service platform terminal 10, the bypassing apparatus 100 for providing content and the content provider 20, thereby providing content transparency to a user (service subscriber).

The profile manager 120 stores and manages service platform profile information on each content provider 20 that provides a service platform. The profile manager 120 manages dimension information of a service provided to a user by each content provider 20. The service platform profile information includes available content information of a service platform provided by the content provider 20. Further, the service platform profile information includes container information and codec information of each content. At the request of the processor 110, the profile manager 120 transmits service platform profile information to the processor 110.

In response to receiving a request for content collection from the processor 110, the content collector 130 requests the content from the content provider 20 and collects content requested by a user through the service platform terminal 10. The content provider 20 provides various types of content to a user through a service platform, and among a plurality of content providers 20 that may be accessible, the content collector 130 requests the content from a content provider 20, which is selected to be able to provide the requested content based on the service platform profile information analyzed by the processor 110. Further, the content collector 130 collects the requested content from the content provider 20, and transmits the collected content to the content converter 140.

In response to receiving a request for content conversion from the processor 110, the content converter 140 converts a format and codec of content received from the content collector 130. The content converter 140 includes a transformatting functional block and a transcoding functional block to convert a container of the received content. The content converter 140 converts the received content into a form that is acceptable (available) in the service platform terminal 10 through the transformatting functional block and the transcoding functional block. Upon converting the content into a form acceptable (available) in the service platform terminal 10, the content converter 140 transmits the converted content to the service platform terminal 10 through sessions allocated by the processor 110.

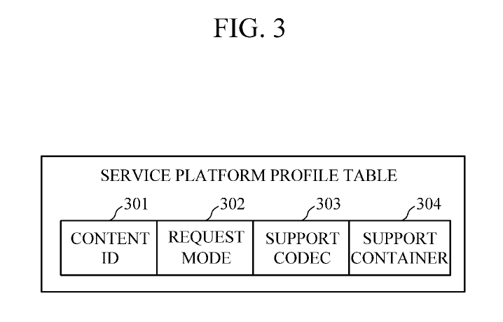

FIG. 3 is a block diagram illustrating an example of service platform profile information of a bypassing apparatus for providing content according to an exemplary embodiment.

Referring to FIG. 3, service platform profile information of the bypassing apparatus 100 for providing content may be configured as a table that includes an ID 301 of content to be provided (hereinafter referred to as content ID), a request mode 302, a support codec 303, and a support container 304.

The content ID 301 is an ID to identify each content provided by the content provider 20. Based on the content ID 301 included in the service platform profile information, the processor 110 identifies content requested by the service platform terminal 10.

The support codec 303 refers to a codec that is required for the content indicated by the content ID 301. Based on the support codec 303 included in the service platform profile information, the processor 110 identifies a codec that is required for the content, and determines whether the codec required for the content is acceptable in the service platform terminal 10.

The support container 304 refers to a format or a container that is required for the content indicated by the content ID 301. Based on the support container 304 included in the service platform profile information, the processor 110 identifies a format or a container that is required for content, and determines whether the format or the container required for the content is acceptable in the service platform terminal 10. Further, the request mode 302 indicates that the service platform profile information relates to the requested content.

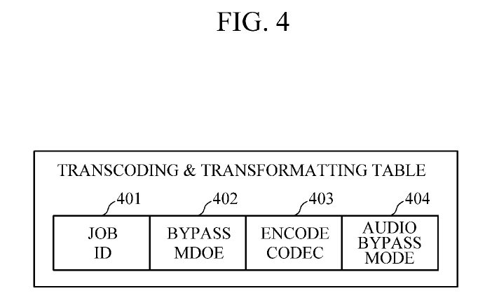

FIG. 4 is a block diagram illustrating an example of a conversion table of a content converter of a bypassing apparatus for providing content according to an exemplary embodiment.

Referring to FIG. 4, the conversion table of the content converter 140 of the bypassing apparatus 100 for providing content includes a job ID 401, a bypass mode 402, an encode codec 403, and an audio bypass mode 404.

The job ID 401 is an ID to identify each job of converting content by the content converter 140 through transcoding and transformatting. Further, based on a determination of the processor 110 whether the content may be acceptable in the service platform terminal 10, the bypass mode 402 indicates the operation of converting content by the content converter 140. The encode codec 403 indicates a codec, which may be acceptable in the service platform terminal 10 by transcoding.

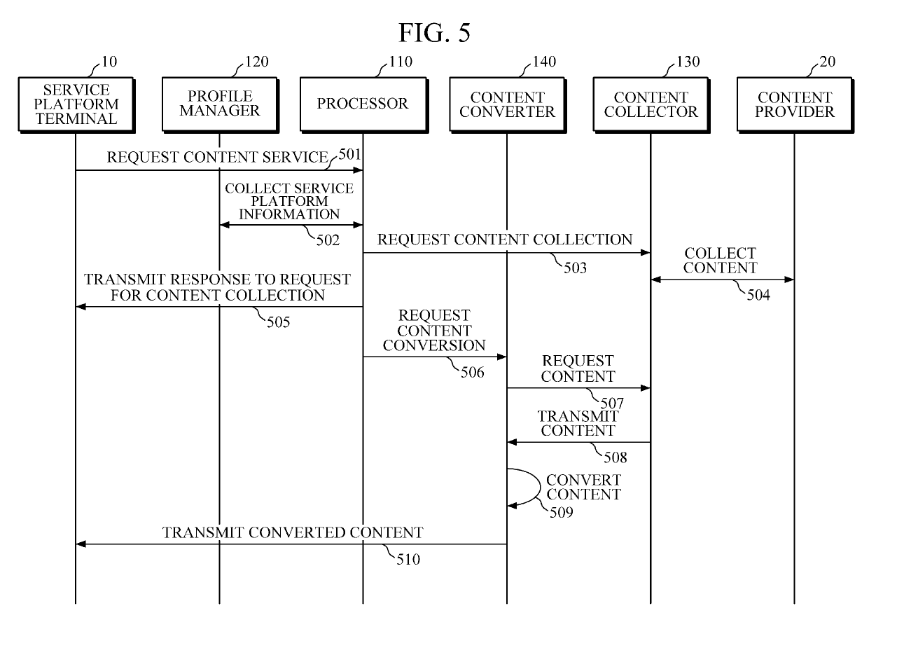

FIG. 5 is a flowchart illustrating a data flow of a bypassing apparatus for providing content according to an exemplary embodiment.

Referring to FIG. 5, in the bypassing apparatus 100 for providing content according to an exemplary embodiment, when a user accesses a service platform via the service platform terminal 10 or executes a service platform application to access the service platform, a request for a content service is transmitted in 501. By using a service platform or the service platform terminal 10 that allows access to a service platform, a user (service subscriber) accesses the service platform to search for a desired content service, and requests the desired content service from the bypassing apparatus 100 for providing content. The service platform may be a web page, or a separate application, which may search for and request content that is provided by the service provider 20. The service platform terminal 10 is a terminal that may access a web page that provides a service platform, or a terminal in which a service platform may be embedded or installed. The service platform terminal 10 may be in various forms, such as a PC, a TV, a smartphone, a tablet PC, and a set top box.

In response to receiving a request for a content service from the service platform terminal 10, the processor 110 retrieves profile information of the service platform from the profile manager 120 to collect service platform information in 502. The processor 110 may collect available content information of the service platform from the profile information of the service platform. The service platform profile information includes available content information of the service platform, which is provided by the content provider 20. Further, the service platform profile information includes container information and codec information of content. Upon identifying the available content information based on the service platform profile information, the processor 110 requests the content collector 130 to collect content requested by a user through the service platform terminal 10 in 503.

In response to receiving a request for collecting content from the processor 110, the content collector 130 requests the content from the content provider 20 and collects the content requested by a user through the service platform terminal 10 in 504. The content provider 20 provides a user with various types of content through a service platform, and among a plurality of content providers 20 that may be accessible, the content collector 130 requests the content from a content provider 20, which is selected to be able to provide the requested content based on the service platform profile information analyzed by the processor 110. Further, the processor 110 transmits a request for collecting content to the content collector 130 and also transmits a response to the request for content collection to the service platform terminal 10 in 505. The processor 110 creates a service channel to the service platform terminal 10, and transmits a response to the request for content collection, which includes a uniform resource locator (URL) for bypassing transmission. In response to receiving a response to the request for content collection from the processor 110, the service platform terminal 10 establishes a real time streaming protocol (RTSP) connection with the bypassing apparatus 100 for providing content.

Based on the service platform profile information, the processor 110 transmits a request for converting content to the content converter 140, so that the content converter 140 may operate a content conversion process in 506. Based on the service platform profile information, the processor 110 may identify container information and codec information of content requested by the service platform terminal 10. Based on the container information and the codec information of the requested content, the processor 110 determines whether the content may be acceptable (available) in the service platform terminal 10. If the content is determined as unacceptable, the processor 110 allocates a series of sessions to secure content conversion resources. Based on the identified container information and codec information, the processor 110 determines whether or not to convert a format and codec of the content and transmits a request for converting content to the content converter 140 so that the content may be converted into the determined format and codec.

In response to receiving the request for converting content from the processor 110, the content converter 140 requests the content from the content collector 130 in 507. Further, in response to the request for collecting content, the content collector 130 transmits the collected content to the content converter 140 in 508.

In response to receiving the request for converting content from the processor 110, the content converter 140 converts the content received from the content collector 130 in 509. The content converter 140 includes a transmformatting functional block and a transcoding functional block to convert a container of the received content. By using the transformatting functional block and the transcoding functional block, the content converter 140 converts the received content into a form that is acceptable (available) in the service platform terminal 10. Upon converting the content into a form that is acceptable (available) in the service platform terminal 10, the content converter 140 transmits the converted content to the service platform terminal 10 through sessions allocated by the processor 110 in 510.

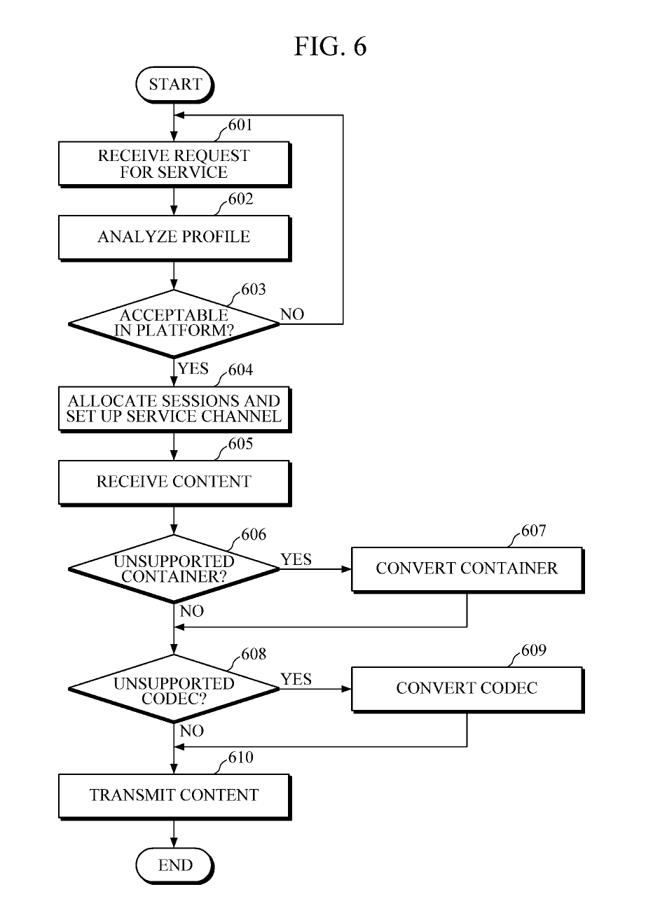

FIG. 6 is a flowchart illustrating an example of a bypassing method for providing content according to an exemplary embodiment.

Referring to FIG. 6, according to an exemplary embodiment, the bypassing method for providing content includes receiving a request for a service, which includes a service ID, in 601. By using a service platform or a service platform terminal that allows access to a service platform, a user (service subscriber) accesses the service platform to search for a desired content service and requests the desired content service from the bypassing apparatus 100 for providing content. The service platform may be a web page, or a separate application, which may search for and request content that is provided by the service provider 20.

In response to receiving the service request, the service platform profile information is analyzed in 602. The service platform profile information includes available content information of the service platform provided by the content provider. Further, the service platform profile information includes container information and codec information of content. The service platform profile information is analyzed to determine whether the requested content is acceptable in the platform in 603. If the content is determined as unacceptable, the bypassing operation is stopped.

If the content is determined as acceptable in the platform, sessions are allocated to provide a bypassing service for providing content and a service channel is set up in 604. Through the service channel, an RTSP connection may be established. By setting up the service channel for content transmission, content transparency may be provided to a user (service provider).

When sessions are allocated to provide a bypassing service for providing content, a request for content is transmitted to a content provider in response to receiving a request for collecting the content, and the requested content is received in 605. The content provider provides various types of content through a service platform, and among a plurality of content providers 20 that may be accessible, the processor 110 requests the content from a content provider 20, which is selected to be able to provide the requested content based on the service platform profile information analyzed by the processor 110.

In response to receiving the content, it is determined, based on the container information included in the service platform profile information, whether the container of the received content is supported in the service platform terminal in 606. If the container is determined to be unsupported based on the identified container information, a series of sessions are allocated to secure content conversion resources, so that the container of the received content is converted into a container that is acceptable in the service platform terminal in 607. The problem of having an unsupported container may be solved by converting the container into a form that is acceptable in the service platform terminal.

Upon solving the problem of having an unsupported container, it is determined whether the codec of the received content is supported in the service platform terminal in 608 based on the codec information included in the service platform profile information. Based on the codec information of the requested content, it is determined whether the content is acceptable (available) in the service platform terminal. If the content is determined to be unacceptable, a series of sessions are allocated to secure content conversion resources, so that the codec of the received content may be converted into a codec that is acceptable in the service platform terminal.

Operations 607 and 609 of converting content may be performed using the transformatting functional block and the transcoding functional block for converting a container of the received content. By using the transformatting functional block and the transcoding functional block, the collected content is converted into a form that is acceptable (available) in the service platform terminal.

Upon converting the content into a form acceptable in the service platform terminal, the converted content is transmitted to the service platform terminal through the allocated service sessions in 610.

The bypassing apparatus and method for providing content may readily provide web content services to service subscribers with access through various service platforms, by managing, as a profile, a protocol for supporting a user receiver and available encoding information included in a service platform, and by monitoring a transmission protocol of content requested by a user and encoding information to allow for receiving and reproducing of unsupported content desired by a service subscriber of the service platform.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A bypassing apparatus for providing content, the apparatus comprising:
a processor configured to determine whether content for which a service request has been received is acceptable in a service platform terminal based on service platform profile information about the content for which a service request has been received;
a content collector configured to collect, from a content provider, the content for which a service request has been received; and
a content converter configured to convert the collected content into a form that is acceptable in the service platform terminal.

2. The apparatus of claim 1, further comprising a profile manager configured to store the service platform profile information and in response to a request of the processor, to transmit, to the processor, service platform profile information about the content for which a service request has been received.

3. The apparatus of claim 1, wherein the processor determines whether the content is acceptable in the service platform terminal based on the service platform profile information including container information and codec information of the content provided by the content provider.

4. The apparatus of claim 1, wherein in response to a determination that the content is acceptable in the service platform terminal, the processor allocates sessions to create a service channel to the service platform terminal.

5. The apparatus of claim 4, wherein the processor allocates the sessions using a real time streaming protocol (RTSP) connection to create the service channel.

6. The apparatus of claim 1, wherein the content converter converts the container of the collected content into a form that is acceptable in the service platform terminal by transformatting.

7. The apparatus of claim 1, wherein the content converter converts the codec of the collected content into a form that is acceptable in the service platform terminal by transcoding.

8. A bypassing method for providing content, the method comprising:
analyzing service platform profile information about content for which a service request has been received;
determining whether the content for which a service request has been received is acceptable in a service platform terminal based on the analyzed service platform profile information;
collecting, from a content provider, the content for which a service request has been received; and
converting the collected content into a form that is acceptable in the service platform terminal.

9. The method of claim 8, wherein the determining whether the content is acceptable in a service platform terminal based on the analyzed service platform profile information comprises determining whether the content is acceptable in the service platform terminal based on the service platform profile information including container information and codec information of content.

10. The method of claim 8, further comprising allocating sessions to create a service channel to the service platform terminal in response to a determination that the content is acceptable in the service platform terminal.

11. The method of claim 10, wherein the allocating of sessions to create a service channel comprises allocating the sessions using the RTSP connection to create the service channel.

12. The method of claim 8, wherein the converting of the collected content into a form that is acceptable in the service platform terminal comprises converting the container of the collected content into a form that is acceptable in the service platform terminal by transformatting.

13. The method of claim 8, wherein the converting of the collected content into a form that is acceptable in the service platform terminal comprises converting the codec of the collected content into a form that is acceptable in the service platform terminal by transcoding.

14. The method of claim 8, further comprising providing the converted content to a user.
